(19) United States
(12) Patent Application Publication
(10) Pub. No.: US 2016/0273835 A1
(43) Pub. Date: Sep. 22, 2016

(54) Freeze Dryer with an Inspection Window

(71) Applicant: Martin Christ Gefriertrocknungsanlagen GmbH, Osterode (DE)

(72) Inventor: Michael Umbach, Bad Grund (DE)

(21) Appl. No.: 15/071,307

(22) Filed: Mar. 16, 2016

(30) Foreign Application Priority Data
Mar. 16, 2015 (EP) 15 159 161.7

(51) Int. Cl. F26B 25/08; F26B 5/06

(52) U.S. Cl. CPC F26B 25/08; F26B 5/06

(57) ABSTRACT

The invention relates to a freeze dryer (1) which comprises an inspection window (15) e.g. in the region of a door (14). According to the invention the inspection window (15) comprises a reduced transmissibility for electromagnetic radiation. This might be provided by coating a base body (16) of the door (14) with a coating or layer (17) having a reduced transmissibility for radiation. The coating or layer might be arranged on the outer side or the inner side of the door (14). It is also possible that a base material of the inspection window (15), e.g. transparent plastic glass, is mixed with an addition having a reduced transmissibility for radiation.

### CROSS REFERENCE TO RELATED APPLICATIONS

This application claims priority to co-pending German patent application No. EP 15 159 161.7 entitled “Gefriertrockner mit einem Sichtfenster”, filed Mar. 16, 2015.

### FIELD OF THE INVENTION

The invention relates to a freeze dryer. Furthermore, the invention relates to a new use of a material.

### BACKGROUND OF THE INVENTION

Freeze dryers are used for a mild drying of a high-class, thermally sensitive drying good, in particular of a pharmaceutical or biochemical drying good. Here, the drying good contains a liquid. It is intended to remove the liquid by the freeze drying process. The liquid is preferably high purity water or a solvent. Generally, a drying good of this type is freeze-dried in containers. Any container (in particular a drying vessel, a small bottle, an ampulla, a bowl or a so-called vial with the drying good located therein) is in the following also denoted as a product.

For a plurality of known embodiments several utility surfaces are located one above the other in a product chamber of a freeze dryer. It is possible to introduce products into the product chamber through an opening wherein it is possible to close the opening by a door and to position the products on the utility surfaces. Then during the freeze drying process at first the product is frozen in the product chamber of the freeze dryer. In the subsequent step a so-called primary drying is provided. This is achieved by a sublimation of the solvent contained in the drying good in the product chamber directly from the frozen state into the gaseous state without the interim occurrence of a liquid phase at a low pressure or a technical vacuum and a low temperature. In an ice condenser chamber connected to the product chamber or being integrally formed by the product chamber, the solvent previously sublimated condenses as ice (e.g. at a cooling coil of the ice condenser chamber). It is possible that a secondary drying follows to the above explained primary drying. For the secondary drying, by means of a pressure decrease and/or an additional heating stronger bound solvent is removed. In the containers of the products in the product chamber the dried drying good remains which is also denoted as lyophilisate. During the freeze drying process, the pressure, the temperature and other parameters are controlled and monitored dependent on a product-specific sublimation pressure curve in order to achieve good and reproducible drying results. In a lot of applications, freeze dryers are operated in a discontinuous fashion.

Freeze dryers are known wherein the housing including the door has a non-transparent design, e.g. with a door made of stainless steel. However, also freeze dryers are known wherein a door is formed with a pane made of inorganic glass or acrylic glass so that the door forms an inspection window. Also for closed door it is possible to inspect the interior of the freeze dryer through the inspection window (cp. e.g. the embodiments “epsilon” of the pilot freeze drying system and the different production systems of the applicant as described and shown on the website www.martinchrist.de [status at the application date of the present patent application]).

The publication EP 1 412 686 B1 (corresponding to U.S. Pat. No. 6,920,701 B2) describes the need to produce a uniform water vapor partial pressure with a uniform pressure distribution also in the region of walls of the chamber and of any door in the product chamber of a freeze dryer. The publication describes the inspection that in the region of walls of the chamber and of the door the temperature of the products does not solely depend on the temperature of the cooled utility plates. Instead, also the temperature of the inner walls of the product chamber has an influence on the temperature of the products. If e.g. the water vapor exiting from the product has a temperature of −40° C., this temperature increases at the utility plates to e.g. −20° C., whereas in some cases the water vapor close to the walls reaches temperatures e.g. of 20° C. Due to these temperature differences, there might be pressure differences of more than 10%. Due to the pressure and temperature differences, there are undesired inhomogeneities of the quality of the freeze drying process of the products. For avoiding the influence of the temperature of the walls of the chamber on the temperature of the product, it is described as being known that the utility plates are designed with an outer edge which protects or shields the product against thermal radiation radiated from the walls of the chamber. The publication EP 1 412 686 B1 additionally proposes to provide the product chamber including the door with a lining by components providing a shielding. This shielding is intended to avoid a heating of the utility plates and the products located thereon by a thermal radiation of the wall of the chamber. For this purpose, the shielding components are tempered by a flow of heating/cooling medium through these components.

For providing homogeneous conditions of the freeze drying process and for avoiding that an ice layer covers the utility surfaces and the products located thereon, the publication DE 10 2007 049 278 B4 proposes to arrange a thermally insulating shield between the lower side of a utility surface radiating cooling energy and another utility surface located there below with products arranged thereon. The thermically insulating shield is intended for providing a shielding such that a transfer of cooling energy from the lower side of the upper utility surface towards the additional utility surface located below with products arranged thereon will be avoided so that an exact control of a freezing profile of the products over time is possible.

CN 203 231 613 U discloses an inspection window of a freeze dryer made of crystal glass.

### SUMMARY OF THE INVENTION

The invention in particular bases upon the following findings (wherein the present invention does not necessarily require that these finding are considered):
a) Investigations have shown that despite of the efforts for homogenizing the process conditions for the simultaneous freeze drying process of a plurality of products, in the freeze dryer inhomogeneities do still occur. Further investigations showed a correlation of the process conditions with the position of the products on the utility surfaces in the freeze dryer. Finally, it has turned out that obviously products in the freeze dryer located in the incidence region of light passing through an inspection window of the freeze dryer (in particular sunlight) are exposed to higher temperatures than products being located in a shadow region of the freeze dryer. Quantitative measurements of these temperature differences have shown that due to the radiation of light products located in the incidence region of the inspection window are up to 6 K warmer than products in shadow regions.
In order to guarantee a reliable freezing of all products, it is accordingly required to design the temperature conditions in the freeze dryer in a way that the freezing temperature will also be reached by products located in the region of insolation. This requirement has the consequence that products located in the shadow regions have to be cooled to a temperature which is up to 6 K below the generally required temperature. This increases the expenditure of energy. On the other hand, in some cases for the provision of the sublimation it is of interest that the temperature is as small as possible below the freezing temperature and/or a fast sublimation process is caused with a small temperature gradient which due to the above explained temperature differences is only possible to a limited extent.
b) It is possible that sensors are arranged within the freeze dryer and/or within the products. In a wireless fashion these sensors send an electromagnetic measurement signal to a receiver which is also located within the freeze dryer. It is also possible that a sensor of this type does not have its own energy supply. In this case, the sensor is stimulated by a transmitter for the energy supply and then sends an e.g. temperature-dependent signal. Here (in particular high-frequency) electromagnetical oscillations or radiations are used. For the stimulation and/or the measurement a frequency in the region of 2.4 GHz is e.g. used. Here in particular also frequencies in the region of ±10% or ±20% from the afore mentioned frequency might be used. In some cases, the intensity of the measurement signal sent by the sensor is only one-hundredth to one-thousandth of the stimulating intensity. If it is intended to dimension the intensity of the sent measurement signal such that it is still possible to receive the measurement signal by a receiver at any location within the freeze dryer where it is generally possible to position the sensor, it is required to dimension the stimulating frequency sufficiently high. Here, in particular the number of reflections of the radiation has to be considered both for the stimulation as well as for the measurement signal. Additionally, losses of the radiation to the environment have to be minimized because these losses decrease the stimulation and/or the intensity of the measurement signal. The investigations building the basis for the invention have shown that significant losses occur in the region of an inspection window of the freeze dryer. In the region of the inspection window there is only a limited reflection whereas a part of the radiation is absorbed by the inspection window or passes the inspection window.
c) It has been found that the radiation explained under b) and the transmittance of the inspection window with respect to the radiation might lead to the result that the electromagnetic compatibility of the freeze dryer cannot be guaranteed. Possibly, e.g. interferences with electronic devices (in particular cell phones) might occur if these are located in the neighborhood of the freeze dryer.

For one embodiment of the inventive freeze dryer it is possible that the freeze drying conditions of the products are homogenized to a larger extent, a propagation of an electromagnetic stimulation of a sensor and/or a propagation of an electromagnetic measurement signal in the freeze dryer is improved and/or the electromagnetic compatibility of the freeze dryer is improved.

The invention proposes to form the inspection window with a reduced transmissibility for radiation. If e.g. an inspection window made of an inorganic glass (or made of organic glass, in particular an acrylic glass or a transparent plastic glass of materials as PMMA, PC, PET, SAN, PVC, . . . ) is used, within the frame of the invention measures will be taken for providing that the transmissibility for radiation of the inventive inspection window is smaller (e.g. in the whole frequency range or only in the frequency range here being of interest 10%, 20%, 30%, 50% or even 70% smaller) than the transmissibility for radiation of an inspection window of the same dimensions made of the same inorganic glass (or made of the same organic glass, in particular of a transparent plastic glass) without the additional inventive measures for reducing the transmissibility for radiation.

By use of the inventive reduction of the transmissibility for radiation, it is possible to at least reduce one or more of the above problems a) to c), in particular to reduce or completely avoid a heating of products in the region of insolation of light in the region of the inspection window (cp. a)) or a reduction of the reflection of electromagnetical radiation in the region of the inspection window (cp. b) and c)) (however, the inventive measures are not limited to those used for avoiding one of the problems which have been mentioned only for giving examples).

For a first embodiment of the invention, the inspection window is formed with a layer, cover or coating having a reduced transmissibility for radiation. Accordingly, it is e.g. possible that the inspection window is formed with different layers or a base body made of a “common material” of the inspection window, e.g. organic glass as transparent plastic glass or inorganic glass. By use of the layer, cover or coating it is possible to additionally reduce the transmissibility for radiation. By dimensioning the layer, cover or coating and by the choice of the material of the layer, cover or coating it is possible to influence the extent of the reduction of the transmissibility for radiation. Here, the layer, cover or coating has to be chosen such that the inspection window is still transparent when viewing through the layer, cover or coating. However, to some extent also deteriorations of the view (as a small darkening and/or a reflecting effect for specific viewing angles through the inspection window) might be acceptable. It is also possible that an existing inspection window is retrofitted with a layer, cover or coating of this type.

Generally, there are a number of options for the design of the inspection window with a layer, cover or coating. In order to mention only some non-limiting examples, it is possible that the inspection window is formed with a base body (e.g. made of inorganic glass or transparent plastic glass). The layer, cover or coating is applied to the inner side of the base body with respect to the freeze dryer or to the outer side of the base body. It is also possible to use a multi-layered design of the base body with a plurality of materials. Here, also a layer or coating having a reduced transmissibility for radiation might be located within the inspection window (so between two adjacent layers made of a different material). It is also possible that a number of layers, covers or coatings having a reduced transmissibility for radiation are used.

Within the frame of the invention, it is possible that the transmissibility for radiation is reduced over the whole area or surface of the inspection window. For a different embodiment, the inspection window might have regions with different reductions of the transmissibility for radiation (e.g. a central field with reduced extent of the reduction of the transmissibility for radiation, e.g. for only limiting the inspection to a limited extend or not limiting the inspection, and an edge region located on the outside from the central region with an increase of the extent of the reduction of the transmissibility for radiation).

For an exemplary embodiment it is possible to use a film, sheet, foil with reduced transmissibility for radiation for the layer, cover or coating. It is possible to adhere the film, sheet or foil to a base body or to an adjacent layer. Any sheet or foil might be formed by a type of film. For the design of the film, sheet or foil there are a number of options. It is possible that a film with an amorphous cobalt alloy is used. To mention another example, a layer having a reduced transmissibility for radiation might be formed by a varnish, paint or finish. It is also possible that for a layer having a reduced transmissibility for radiation a layer vapor-deposited upon a base body or an adjacent layer is used. It is also possible that a layer or cover with a reduced transmissibility for radiation is formed with a web, texture web or grid. Here, for the material forming the web, texture or grid any material (in particular polyester, metal, stainless steel, silver-polyamide-fibers and the like) can be used. Here it is also possible that the layer formed with the web, texture or grid is penetrated by a material from an adjacent layer or from a base body so that the web, texture or grid is “embedded” into the material of the adjacent layer or base body. To only mention another non-limiting example for the formation of the layer, cover or coating having a reduced transmissibility for radiation, also a card web, fibrous web, non-woven material or non-woven fabric (e.g. a carbonized polyester non-woven fabric) can be used which is penetrated by a material from an adjacent layer or a base body.

For another embodiment of the invention, the inspection window is generally formed with a common material for the formation of the inspection window (in particular inorganic glass, mineral glass, crystal glass, organic glass, acrylic glass or a transparent plastic glass). For this proposal, an addition having a reduced transmissibility for radiation is added to this material of the inspection window. The addition might e.g. be dissolved, suspended or dispersed in the afore mentioned material or might be e.g. formed by particles added to the afore mentioned material. In the latter case, the particles are locally distributed in the afore mentioned material without being dissolved or suspended. By the choice of the addition and by dimensioning the addition (in particular the percent by weight of the addition in the material), it is possible to specifically influence the extent of the reduction of the transmissibility for radiation.

It is generally possible that the inspection window and in particular the layer, cover or coating having the reduced transmissibility for radiation does not have an electrical grounding. However, for some embodiments (in particular when reducing the transmissibility for radiation in a low frequency region) it might be of advantage that the inspection window (here in particular the layer, cover or coating with reduced transmissibility for radiation) comprises an electrical grounding. Here, the reduction of the transmissibility for radiation might in the low frequency region or high frequency region in the first instance depend on the type of grounding (in particular depend on the electrical grounding being provided at at least one point or in at least one area).

Within the frame of the invention, different thicknesses of the inspection window (and if present including the layer, cover or coating with reduced transmissibility for radiation) are possible. Preferably, an inspection window having a thickness in the region of 4 cm to 6 cm is used. Here it is possible that a layer, cover or coating having a reduced transmissibility for radiation only has a very small thickness (e.g. smaller than 100 μm, smaller than 50 μm or even smaller than 10 μm or 5 μm).

Within the frame of the invention, it is possible that the transmissibility for radiation is reduced in any relevant frequency region. For one inventive proposal, the inspection window comprises a reduced transmissibility for radiation for light in the frequency region from 300 GHz to 400 GHz which correlates to the infrared spectrum of the radiation of the sun. Here, within the frame of the invention there is e.g. a reduction of the transmissibility for radiation in the whole frequency region of 10%, 20%, 30%, 50% or even 70%. This embodiment bases on the finding that the afore mentioned undesired effect of a heating of the products exposed to the incident radiation through the inspection window primarily occurs due to the infrared spectrum of the solar light.

For another embodiment of the inventive freeze dryer, at least one or a sensor is located within the interior of the freeze dryer. The sensor is stimulated by a stimulation frequency from an external stimulation for the supply of energy to the sensor and/or the sensor comprises a measurement signal frequency for wirelessly transmitting a measurement signal to a receiver located remote from the interior of the freeze dryer. For this design it might be advantageous that the inspection window comprises a reduced transmissibility for radiation in the region of the stimulating frequency and/or the measurement signal frequency. This means that the taken measures for reducing the transmissibility for radiation of the inspection window are adapted to the simulating frequency and/or the measurement signal frequency. To mention only one non-limiting example, for the choice of a freeze dryer as described in the publication DE 10 2006 019 641 B4 the transmissibility for radiation might be reduced in a frequency range from 1.5 GHz to 3 GHz (preferably in a frequency range from 2.0 to 2.8 GHz or 2.2 to 2.6 GHz). Here it is also possible that a sending antenna of the sensor in a multifunctional way also forms a receiving antenna.

For another embodiment the inspection window comprises a reduced transmissibility for radiation in a frequency range of 500 MHz, 1,800 MHz and/or 1,900 MHz (which also covers deviations from the afore mentioned frequencies of ±5%, ±10% or ±20%). A reduction of the to transmissibility for radiation in this frequency region has shown to be very effective for increasing the electromagnetic compatibility (in particular in connection with cell phones or transmitters in the radio technology located in the neighborhood of the freeze dryer).

Within the frame of the invention, it is also possible that a reduced transmissibility for radiation is provided in different afore mentioned frequency regions. Here, it is also possible that different layer, covers, coatings or additions for different frequency regions are used at the same inspection window.

The transmissibility for an electromagnetic radiation as well as the test methodology for measuring a reduction of the transmissibility for radiation is in particular defined in the standards ASTM D4935-10, IEEE Std 299-2006, IEEEE Std 1128-1998 and ASTM A698/A698M-07. Here, it is possible to define the transmissibility for radiation by a so-called shielding effectiveness (concerning the shielding effectiveness reference is made to the afore mentioned standards). In a particular embodiment of the invention, the inspection window comprises (at least in one of the frequency regions here mentioned or in the whole frequency region) a shielding effectiveness according to the standard IEEE 299-2006 of 20 dB (preferably of at least 25 dB or a shielding effectiveness in the range from 25 dB to 32 dB).

Another aspect of the invention cares for the edge region of the layer, coating or cover having a reduced transmissibility for radiation. In an edge region of this type, in some cases the layer, cover or coating is subjected with particular biases. Due to mechanical biases, the present temperatures and pressures it is e.g. possible that in the edge region a layer or cover separates. In some cases there are also undesired optical properties of the inspection window in the edge region (e.g. a changing shading, a changing transparency or a different refraction). For a particular embodiment of the invention the layer, cover or coating which comprises the reduced transmissibility for radiation is covered by a cover. To mention only some examples the cover might e.g. be formed by local covering or fastening elements, a capping or covering strip or a profile providing a covering which encompasses a base body of the inspection window. It is also possible that the covering serves for mounting or fixation by which (in some cases additional to e.g. adhesive means) a fixation of the layer or cover to the base body of the inspection window is provided. In an extreme case, a cover or fixation of this type might be formed by a type of frame of the inspection window which
might be formed in one piece or with a plurality of pieces and/or
extends in an edge region of the inspection window or which might continuously surround or enclose the base body of the inspection window.

Here it is also possible that the frame is used for further purposes (e.g. for mounting the inspection window with other housing parts of the freeze dryer or for holding a hinge).

Within the frame of the invention, there are a lot of options for the type of design of the inspection window. An inspection window might e.g. form a part of the housing of the freeze dryer. For a particular proposal of the invention, the inspection window forms a door or flap of the freeze dryer which can e.g. be closed and opened for loading and unloading the freeze dryer. This design in particular uses the fact that usually a door or flap for loading or unloading of the freeze dryer is located in a central region of the housing of the freeze dryer with a small distance to the utility surfaces of the freeze dryer. Accordingly, when locating the inspection window in the region of the door or flap it is at the same time provided that there is a good view into the interior of the freeze dryer and upon the products through the inspection window.

Generally per se advantages result from the use of the inspection window with reduced transmissibility for radiation. For another proposal, the invention uses the homogenization of the temperature of products in the freeze dryer achieved by the inspection window with reduced transmissibility for radiation. For this purpose a control unit of the freeze dryer is equipped with control logic. The control unit causes a temperature in the freeze dryer which differs from the freezing temperature of the products which are freeze-dried in the freeze dryer by a difference temperature. Here, the difference temperature is adapted to the shielding effectiveness of the inspection window. This can be illustrated on the basis of a simplified embodiment:

If a freezing temperature is approximately 0° C., before the start of the primary drying process the products should have a temperature of at least −4° C. and if without the inventive reduction of the transmissibility for radiation of the inspection window due to the insolation of light the temperature change of the samples in the freeze dryer is 6 K, then according to the prior art the control unit of the freeze dryer has to provide a temperature of the samples which is −10° C. for samples not biased with the radiation of light. Due to the inventive design of the inspection window with reduced transmissibility for radiation, the insolation of light only leads to a temperature difference of 1 K (in particular 0.7 K or 0.5 K) between products in the region of incidence of light and products in the shadow region. According to the invention, in this case the control by the control logic of the control unit of the freeze dryer only provides a temperature of −5° C. (e.g. −4.7° C. or −4.5° C.). Here, by the inventive measures it can nevertheless be guaranteed that all of the samples have a maximum temperature of −4° C. Due to the increased inventive shielding effectiveness of the inspection window, an adaptation of the difference temperature is possible which reduces the use of energy and provides a fast gradual sublimation (in some cases also with a reduced temperature gradient).

For another embodiment of the invention (also) a front side of the inspection window is equipped with a layer, cover or coating having a reduced transmissibility for radiation. This embodiment of the invention bases on the finding that in some cases there is an exchange of radiation between the interior and the exterior of the freeze dryer in the edge region of the inspection window (in one direction or in both directions). By use of the layer, cover or coating having a reduced transmissibility for radiation located at the front side of the inspection window it is possible to reduce this exchange of radiation. Here, the invention both covers embodiments wherein only a part of the front side of the inspection window is equipped with the cover, layer or coating having the reduced transmissibility for radiation as well as embodiments wherein the front side of the inspection window is continuously and circumferentially equipped with a layer, cover or coating of this type.

For another embodiment of the invention, the wall of the housing of a product chamber of the freeze dryer forms the inspection window. Here, the product chamber formed by the wall of the housing is formed separately from an outer housing of the freeze dryer and it is possible to take the product chamber out of the outer housing. It is possible that also the outer housing forms another inspection window. Accordingly, it is possible to inspect the products located in the product chamber in the product chamber in a state wherein they have been taken out of the outer housing. The products are then also visible through the second inspection window if the product chamber has been inserted into the outer housing. Product chambers of this type can e.g. be taken from the transparent product chambers denoted as “Trocknungskammern” (engl.: drying chambers) for the embodiments ALPHA to DELTA on the website www.martinchrist.de. Here, the product chambers are formed by hollow cylindrical containers closed by a transparent lid (e.g. made of a transparent plastic glass). These product chambers are able to house the products in its interior.

It is also possible that a base module of the freeze dryer forming an ice condenser chamber is used in different variants. For a two-chamber principle, the base module is separated by an intermediate plate comprising a valve from a hood-like housing which forms the product chamber. Instead, for a single-chamber principle, the utility surface for the products is formed in the interior of the ice condenser chamber formed by the base module. In this case the base module is closed by a lid. In these cases the lid or the housing limiting the product chamber comprises the inspection window. Here, preferably the whole lid or the whole housing is made of any glass material and the measures taken above for reducing of the transmissibility for radiation have been taken.

Generally, it is known to use a web, layer, cover, coating, non-woven material, varnish, paint, finish, film, grid and/or mesh which reduces the transmissibility for radiation for different areas of application, in particular for windows of buildings, for clothing, curtains, drapes, baldachins, protective suits, medical devices, exsiccators, micro-biological incubators, shieldings of computing centers and the like. According to the invention, for the first time the use of a web, layer, cover, coating, non-woven material, varnish, paint, finish, film, grid and/or mesh of this type with a reduced transmissibility for radiation or of an addition is proposed for an inspection window of a freeze dryer.

It is in particular possible to use the at least one layer, cover or coating as a specifically adapted filter which lets radiation in the visible region pass but at the same time reflects or absorbs electromagnetic radiation in a predetermined wavelength region. In order to only mention an example, it is possible to selectively filter in a predetermined wavelength region a wavelength or wavelength region being harmful for the product (as e.g. required for marker substances in the medical field which respond to a specific wavelength).

For an alternative to the shielding of a heat radiation and/or a HF-radiation or cumulatively thereto there might also be a shielding of at least one specific frequency which has a significant impact upon the function of the product. To mention only one non-limiting example, the products might be fluorescent cancer cell markers which are activated by electromagnetic waves having a specific frequency. During the manufacturing process, which also includes the process step of freeze drying, the provision of the required mode of operation of the product requires that the product is protected against electromagnetic radiation having this specific frequency. Manufacturers of products of this type are e.g. ROTOP PHARMAKA GmbH, Bautzner Landstr. 400, 01328 Dresden and Naradowe Centrum Badan Jadrowych, Osrodek Radioizotopow POLATOM ul. Andrzeja Soltana 7 05-400 Otwock-Swierk Polska.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIGS. 1 to 5 schematically show different embodiments of a freeze dryer.

FIG. 6 shows in a front view a door of a freeze dryer comprising an inspection window.

FIG. 7 shows a section VII-VII through the door of FIG. 6.

FIG. 8 shows a detail VIII of the section VII-VII of FIG. 7.

FIG. 9 shows in a front view another door of a freeze dryer which comprises an inspection window.

FIG. 10 shows a section X-X of the door of FIG. 9.

FIG. 11 shows a detail XI of the section X-X of FIG. 10.

FIGS. 12 to 14 show (in a schematic view) the use of a base module of an ice condenser chamber for different embodiments of a freeze dryer.

### DETAILED DESCRIPTION

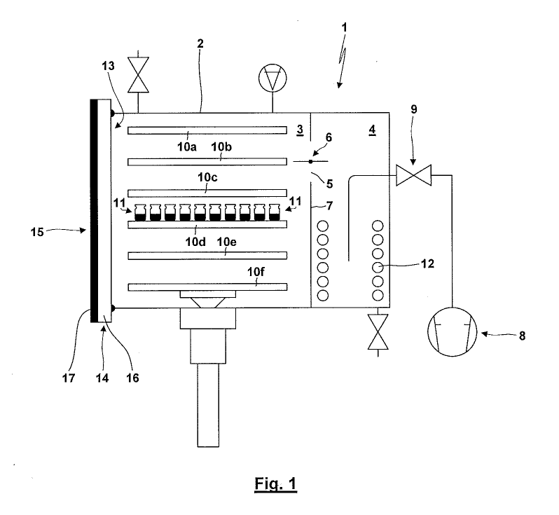

Referring now in greater detail to the drawings, FIG. 1 schematically shows a freeze dryer 1. The freeze dryer 1 comprises a housing 2. A product chamber 3 (which can here also be named a drying chamber) and an ice condenser chamber 4 are formed in the housing 2. By an opening 5 the product chamber 3 and the ice condenser chamber 4 are connected to each other. It is possible to close the opening 5 by a valve 6. For the shown embodiment, the product chamber 3 and the ice condenser chamber 4 are separated from each other by a separating wall 7 which forms the opening 5. However, for different embodiments it is also possible that the product chamber 3 and the ice condenser chamber 4 are permanently fluidly connected to each other or even formed by a common chamber. A cooling device 12 (in particular a cooling coil) is located in the ice condenser chamber 4. During the freeze drying process humility taken from the products condenses in the form of ice at the cooling device 12. For the shown embodiment a pump 8 is connected (here with an interposition of a valve 9) to the ice condenser chamber 4. By means of the pump 8 it is possible to define the pressure conditions in the product chamber 3 and the ice condenser chamber 4, in particular under provision of a technical vacuum. There is a plurality of utility surfaces 10a, 10b, . . . in the product chamber 3. The utility surfaces 10a, 10b, . . . are arranged parallel to each other and one above the other. It is possible to position a plurality of products 11 (in particular vials) on the utility surfaces 10 (which is only shown for one utility surface 10d for simplification of the illustration). The design of the pressure and temperature conditions in the product chamber 3 and the ice condenser chamber 4 according to the needs is provided by the pump 8, in some cases further pumps or connections to a pressure source and/or pressure sink, the cooling device 12 and in some cases further cooling and/or heating devices and in particular by passing a tempering fluid through the utility surfaces 10. The utility surfaces 10 can be fixed in the freeze dryer 1 or can be adjusted with respect to their levels, which is in particular the case for an automized loading and unloading. With respect to constructive design details, constructive design variants and the formation of pressure control devices, heating devices and cooling devices as well as the process control of the freeze dryer 1, reference is made to the embodiments known by the person with skill in the art, to the relevant prior art concerning freeze dryers documented in protective right applications and protective rights and in particular to embodiments of freeze dryers as disclosed on the website www.martinchrist.de. Within the frame of the invention, a “freeze dryer” also covers a freeze dryer system with an automized loading and unloading process (differing from the embodiments shown here).

The housing 2 is generally non-transparent and electromagnetically shielded. The housing 2 can e.g. generally be manufactured from stainless steel or at least be equipped with a cover and/or lining made of stainless steel. The housing 2 comprises an opening 13 which is here located in the region of the product chamber 3 and by which it is possible to get access to the utility surfaces 10 from the outside so that it is possible to (automatically or manually) load and unload the freeze dryer 1 through the opening 13. The opening 13 is (in a manual or an automatic fashion) closable by a door or flap 14. The door or flap 14 forms an inspection window 15 through which it is possible to inspect the interior of the freeze dryer 1 (here the interior of the product chamber 3) and to inspect the utility surface 10 with products 11.

In FIG. 1 as an example a door 14 is shown which is mounted for being pivoted around a vertical axis for opening and pressure-tight closing of the opening 13. Here the door 14 comprises an at least partially transparent inspection window 15 by which it is possible to get insight from the outside to the interior of the product chamber 3 with the utility surfaces 10 and the products 11.

In FIGS. 1 to 4 a base body 16 of the door 14 is shown as a white area whereas a layer, cover or coating 17 is shown as a black area. Here, the base body 16 is formed with a transparent material common for forming doors 14 of this type (in particular inorganic glass or crystal glass or organic glass, in particular transparent plastic glass made of materials as PMMA, PC, PET, SAN, PVC and the like). According to FIG. 1, a layer, cover, coating 17 is located on the outer side of the base body 16. It is e.g. possible that the layer 17 is splashed to the base body 16 (or vice versa), the layer 17 and the base body 16 are adhered to each other or a cover or coating 17 is adhered to the base body 16. Here, the layer, cover, coating 17 might also be formed by a web, non-woven material, varnish, paint, finish, foil or film, grid and/or mesh.

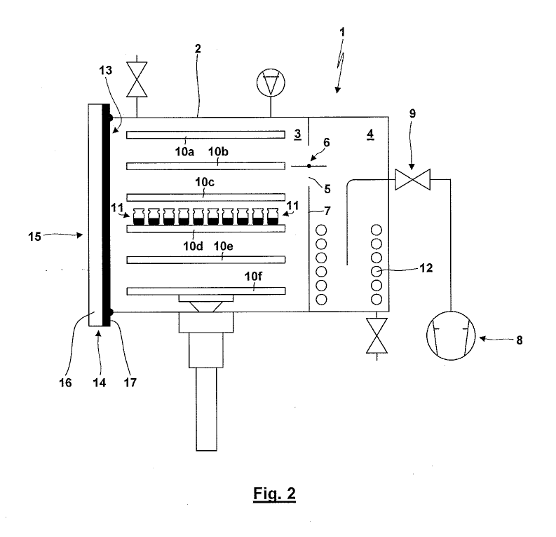

For the embodiment shown in FIG. 2 on the inner side of the door 14 the layer, cover or coating 17 is applied or connected to the base body 16.

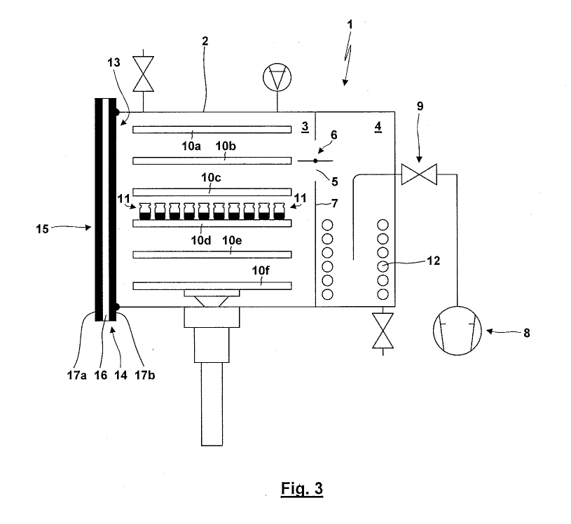

For the embodiment shown in FIG. 3 the base body 16 of the door 14 is equipped with a layers, covers or coatings 17a, 17b on both the inner side as well as the outer side.

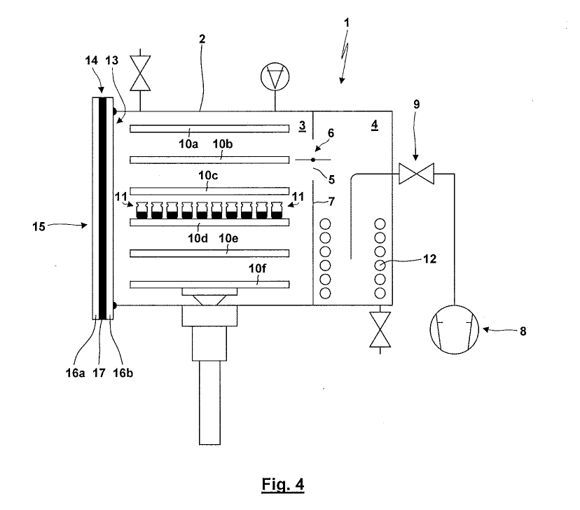

For the embodiment shown in FIG. 4 the door on its outer side as well as on its inner side comprises a layer or base body 16a, 16b. In this case the layer, cover or coating 17 is located between the base bodies or layers 16a, 16b. The layer, cover or coating is preferably connected to the two base bodies 16a, 16b by material bond or by an adhesive.

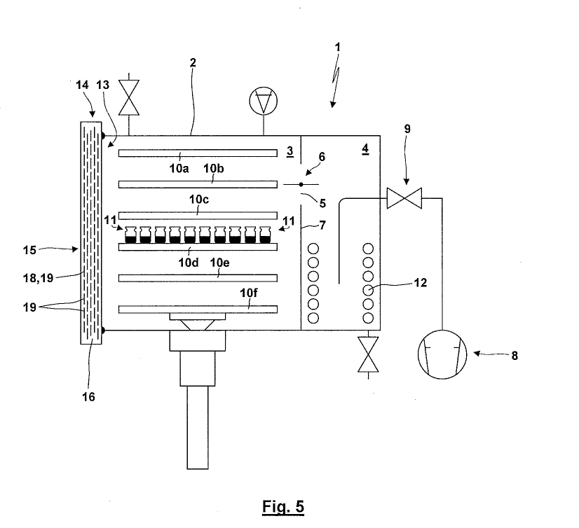

For the embodiment shown in FIG. 5 the material of the base body 16 of the door 14 comprises an addition 18. Preferably, the addition 18 is formed by particles 19 which are not dissolved or suspended in the material of the base body 16 but stochastically distributed in the material of the base body 16.

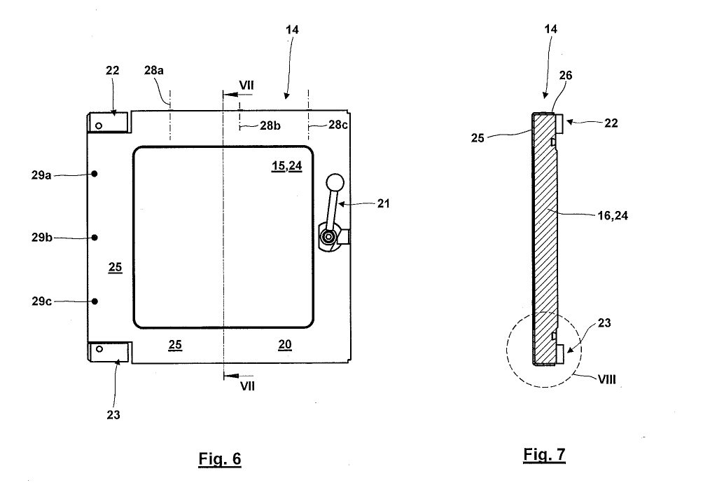

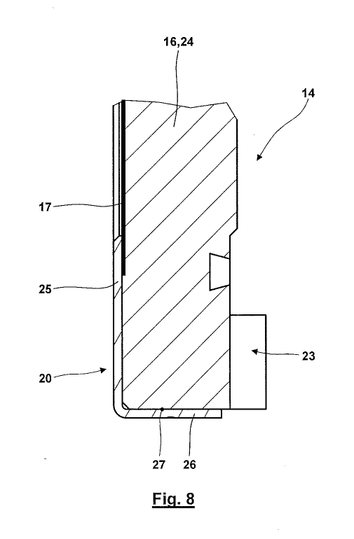

FIGS. 6 to 8 show an embodiment of a door 14 in larger detail. The door 14 comprises an inspection window 15 which has a square form with rounded corners. In the edge region the door 14 comprises a cover or a frame 20 (in the following also only “cover 20”) which is preferably not transparent. FIG. 6 on the one hand shows a closing mechanism here formed with a lever by which a gas-tight closed position of the door 14 can be achieved and secured. On the other hand, the door 14 in the lateral edge region comprises hinge elements 22, 23. By the hinge elements 22, 23 it is possible to link the door 14 to the housing 2 of the freeze dryer 1 under provision of a pivoting degree of freedom of the door 14 around a vertical axis from the open position into the closed position and vice versa. For this embodiment the base body 16 of the door 14 is formed by a glass pane 24 (in particular of transparent plastic glass) and/or has a thickness in the region of 4 to 6 cm. At least in the region of the inspection window 15 the layer, cover or coating 17 is applied upon the outer side of the glass pane 24. In the detail VIII of the cross-section according to FIG. 7 shown in FIG. 8, the cover 20 is L-shaped. One leg 25 of the L contacts the glass pane 24 on the side where also the layer, cover or coating 17 is located. The other leg 26 of the L contacts the outer front side 27 of the base body 16 (here of the glass pane 24). On the outer side of the door 14 the leg 25 of the cover 20 forms a frame surrounding the inspection window 15 and limiting the inspection window 15 in outer direction. The leg 26 builds a kind of border of the base body 16. For the shown embodiment the cover 20 is formed by one single piece (without this necessarily being the case). By screws 28, 29 the cover 20 is screwed to the base body 16. The screws 29 are screwed into the base body from the front side of the door 14 with a screwing direction having an orientation vertical to the drawing plane according to FIG. 6. The screws 28 are screwed vertical to the front sides 27 of the base body 16. For the shown embodiment the leg 25 of the cover 20 overlaps the layer, cover or coating 17. It is also possible that any cover or coating 17 is clamped between the leg 25 of the cover 20 and the base body 16 and/or that the leg 25 of the cover 20 protects the edge region of the layer, cover or coating 17. It is also possible (differing from the detail VIII according to FIG. 8) that the leg 25 of the cover 20 directly follows to the layer, cover or coating 17. Preferably, the closing mechanism 21 and the hinge elements 22, 23 are supported by the frame-like cover 20. The base body 16 and the layer, cover or coating 17 are supported by the frame-like cover 20 by the screws 28, 29.

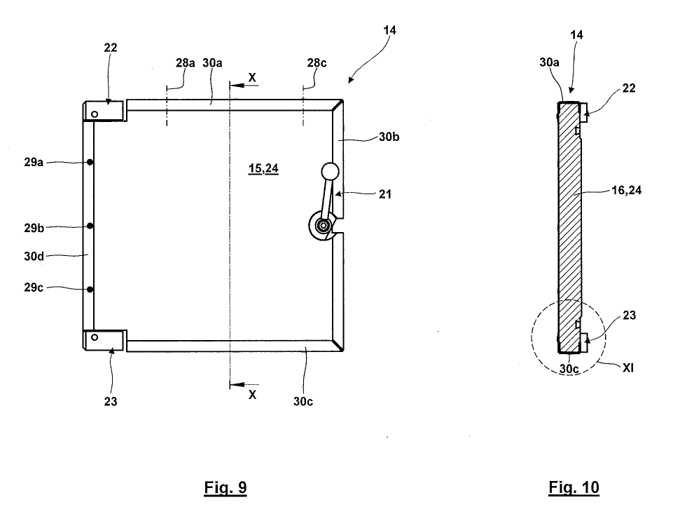

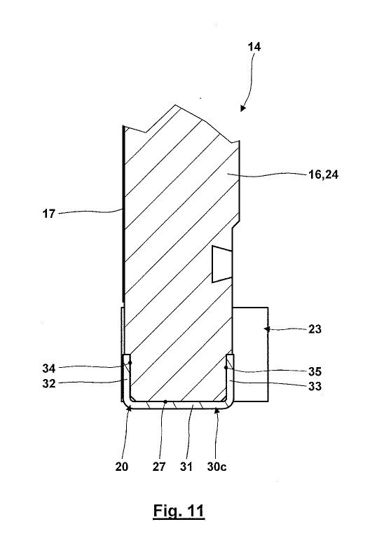

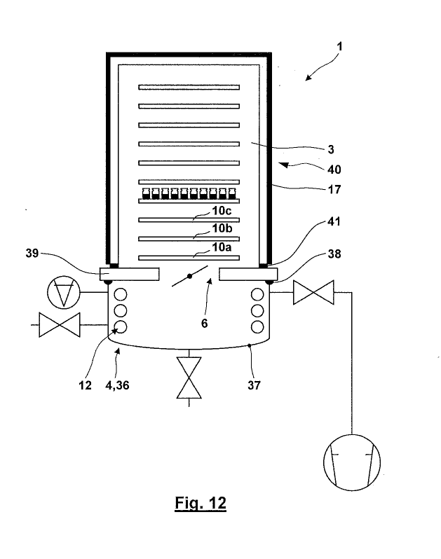

For the embodiment according to FIGS. 9 to 11 the frame or the cover 20 is not formed by one single piece. Instead, here a plurality of segments 30a, 30b, 30c, 30d is used for forming the cover or the frame 20. The segments 30 are formed by U-profiles. The base legs 31 of the segments 30 are each screwed with the respective front sides 27 of the base body 16. The outer edge regions of the base body 16 are housed between the side legs 32, 33. Preferably, the edge regions of the base body 16 housed between the side legs 32, 33 are brought to the required free distance between the side legs 32, 33 by milling with the formation of milled recesses 34, 35, in particular with a clearance fit, an interference fit or a press fit. In this way it is possible to provide that remote from the milled recesses 35 the base body 16 is manufactured with a thickness having a comparatively large tolerance (e.g. due to a casting process with tolerances up to a plurality of millimeters). It is also possible (as can be seen in FIG. 9) that the segments 30a, 30b respectively 30b, 30c build a kind of miter. In this case, the closing mechanism 21 is preferably supported by the segment 30b whereas the hinge elements 22, 23 are supported by the segment 30d. For the embodiment of FIGS. 9 to 11, the base body 16 is e.g. manufactured from a transparent plastic glass with an addition 18. As an alternative or cumulative measure it is possible that the base body 16 comprises a layer, cover, coating 17.

The cover or frame 20 or the segments 30 are preferably made of stainless steel. Any materials which are at least partially transparent can be used for the base body 16. Here in particular PMMA, PET or PC or glass can be used. Differing from the shown embodiment, it is possible that an inspection window 15 is not formed by a door or flap 14. Instead, e.g. containers for a drying chamber as disclosed on the website www.martinchrist.de might form the inspection window 15 and might accordingly be equipped with a cover, layer or coating 17 and/or an addition 18 for reducing the transmissibility for radiation.

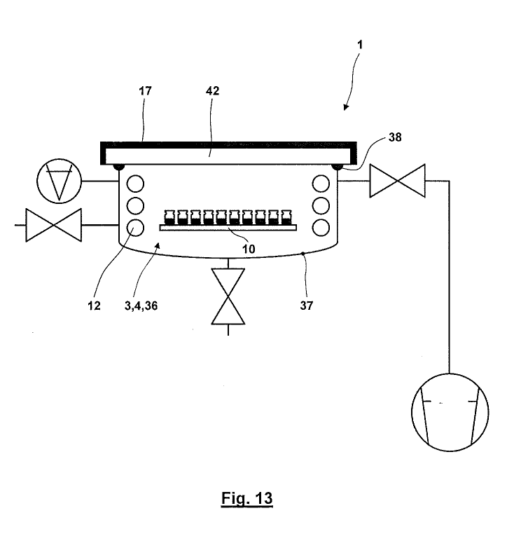

FIG. 12 schematically shows another embodiment of a freeze dryer 1 wherein the ice condenser chamber 4 is formed by a base module 36 which comprises a trough-like or pot-like housing 37 with a cooling device 12 located therein. The required ports for pressurization and deaeration and for producing the vacuum are provided at the housing. The housing 37 is open in upper direction. By means of a sealing element 38 an intermediate plate 39 is supported upon the housing 37 under the provision of a sealing effect. In particular in the region of a centered through bore the intermediate plate 39 comprises the valve 6. A rack with utility surfaces 10a, 10b, . . . is supported (in a way not further shown) by the intermediate plate 39. The utility surfaces 10 are housed in a housing 40 which is open towards the base module 36 and the intermediate plate 39. The housing 40 is sealed with respect to the intermediate plate 39 by a sealing element 41. For the shown embodiment according to FIG. 12 the freeze dryer 1 is a two-chamber freeze dryer wherein the base module 36 forms the ice condenser chamber 4, whereas the housing 40 limits the product chamber 3. The ice condenser chamber 4 and the product chamber 3 are separated from each other by the intermediate plate 39 and the valve 6. The housing 37 has the shape of a rectangular block or a cylinder so that there is a cross-section corresponding to an U (arranged upside down) as shown in FIG. 12. Here the housing 40 is partially or preferably completely made from an inorganic glass or an organic glass with the above mentioned materials. The housing has a reduced transmissibility for radiation which might be provided by the cover or coating 17 shown in FIG. 12. The cover or coating 17 might be provided on the outer side, on the inner side or as an intermediate layer of the housing 40. It is also possible that a wall of the housing 40 comprises particles 19 reducing the transmissibility for radiation or with a different addition 18. Here, generally all of the afore mentioned measures for reducing the transmissibility for radiation might also be used for the housing 40. ###

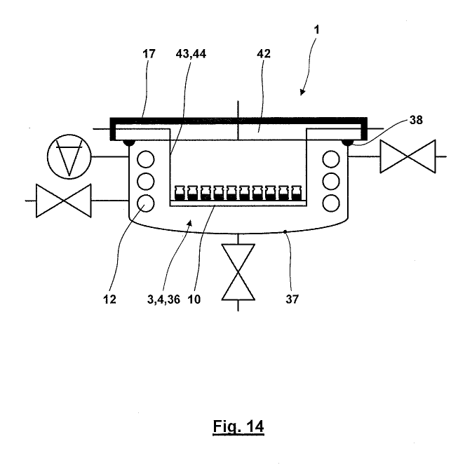

FIG. 13 shows a differing embodiment of a freeze dryer 1. However, here also the base module 36 shown in FIG. 12 is used but in this case there is no intermediate plate 39 and no U-shaped housing 40. Instead, a lid 42 is supported under provision of a sealing effect by a sealing element 38 at the housing 37 of the base module 36. Here the lid 42 is made of any glass material wherein the afore mentioned measures for reducing the transmissibility for radiation have been taken. For the embodiment shown in FIG. 13 on the outside the lid 42 comprises a cover or coating 17. In this case the utility surface 10 is directly arranged in the ice condenser chamber 4. The product chamber 3 and the ice condenser chamber 4 are formed as an integral chamber so that here the one-chamber principle is used.

According to FIG. 13 the utility surface 10 is supported directly at the housing 37 in a way not further shown (e.g. by a rack). Instead, FIG. 14 discloses an embodiment wherein also a one-chamber principle is used and the same base module 36 as shown in FIGS. 12 and 13 is used. Also here the lid 42 is supported via a sealing element 38 at the housing 37. Suitable measures for reducing the transmissibility for radiation of the lid 42 have been taken. However, in this case the utility surface 10 is mounted to the lid 42 which can be provided by struts 43 which when distributed in circumferential direction extend from an edge of the utility surface 10 in vertical direction up to the lid 40. It is possible that the struts contain cables or pipes 44 which in some cases serve for the supply and sending of measurement signals and/or for the supply of electrical voltage for heating and/or cooling and/or for the supply and/or removal of a fluid for cooling and/or heating the utility surface 10. The supply and/or removal might also (instead of a path via the lid 42) be provided via the intermediate plate 39 or via the housing 37.

In the simplest case for the embodiment according to FIGS. 12 to 14 the housing 40, the intermediate plate 39 and the lid 42 are fixed to the housing 37 by the pressure conditions so that with the deaeration of the ice condenser chamber 4 and/or the product chamber 3 the pressing force between the afore mentioned components will automatically be increased and for the removal of the technical vacuum a simple assembly and disassembly is possible. Any differing measures for connecting and fixing might be taken. For the embodiments of FIGS. 12 to 14 the housing 40 or the lid 42 forms the inspection window 15.

In the following (without a limitation of the invention to these embodiments being intended) examples are given for usable layers, covers or coatings 17 and/or additions 18 by which a reduction of the transmissibility for radiation might be provided:
It is possible to use a self-adhering foil or film having a shielding effectiveness of more than 20 dB or more than 30 dB and comprising a material thickness of more than 35 μm or more than 75 μm. It is possible that the self-adhering effect of the foil or film is provided by a rear-sided water-activated and pressure-activated adhesive. A foil or film of this type is e.g. commercially available under the label “RDF62” or “RDF72” of the company YSHIELD (cp. www.yshield.com). These foils or films have a transmissibility for light of 62% respectively 72%.
It is also possible that a layer, cover or coating 17 is equipped with an edge sealing, e.g. silicone (e.g. label “DOW Corning 796”) in an edge region.
Also so-called solar protection films can be used which are distributed under the label “3M” (registered trademark) as well as “Plastic S15” by the company 3M Deutschland GmbH.
It is also possible that a shielding web made of stainless steel is used which causes a shielding effectiveness of at least 100 dB at a frequency of 1 kHz, of at least 95 dB at a frequency of 1 MHz, of at least 55 dB at a frequency of 100 MHz, of at least 40 dB at a frequency of 1 GHz and of at least 25 dB at a frequency of 10 GHz. The mesh might e.g. have a mesh size in the region of 0.08 to 0.12 mm and a weight per area of 380 to 420 g/m². A shielding web of this type is e.g. distributed by the company Aaronia AG under the label “Aaronia Mesh”, see the data sheet “Feuerfestes Abschirmgewebe Aaronia Mesh” Rev. 1.1, 19.09.2014, s. a. www.aaronia.de.
It is also possible to use a shielding web made of a woven material comprising a silver/polyamide-mixture (20%/80%). A web of this type might have a web size in the region 0.5 to 0.9 mm with a diameter of 0.08 mm to 0.12 mm and a weight of 15 g/m²±20%. By use of a web of the type it is possible to provide a shielding of more than 40 dB at a frequency of 10 GHz and more than 45 dB at a frequency of more than 1 GHz. A web of this type is e.g. distributed by the company Aaronia AG under the label “Aaronia-Shield” (registered trademark), cp. the data sheet “50 dB EMV Abschirmung Abschirmstoff Aaronia-Shield”, Rev. 1.7, Sep. 19, 2014, s. a. www.aaronia.de.
Also any wire mesh according to DIN ISO 9044 can be used, cp. the mesh sizes, wire diameters, spacing, chains, filling, wefts, open sieve areas, weaves and web or mesh types, mesh numbers per longitudinal unit, materials, mesh shapes with square mesh, longitudinal mesh or width-mesh, mesh types with wire mesh or wire grid, linen (smooth) weave, form A, wire mesh with body weaves, wave grid, form C, DOKA-grid, form D, EGLA-grid, form E. Wire meshes of this type are in particular distributed by the company HAVER & BOECKER, cp. www.diedrahtweber.com.
Also a use of a shielding surface coating is possible as e.g. distributed by the company GfO Gesellschaft für Oberflachentechnik mbH under the label “ELAMET” (registered trademark) (see also www.gfo-online.com). Within the frame of the invention it is possible that coatings of this type are applied in a vacuum from a vapor upon organic glass surfaces and might e.g. contain aluminum and/or indium-tin-oxyd. A coating of this type might have a thickness of less than 2.5 μm, 4 μm or 5 μm. It is also possible that a coating of this type is formed with a copper-lead-component and/or copper-nickel-component or copper-NiCR-component or copper-steel-component.
Possible is also the use of a metalized polyester web which preferably comprises a shielding effectiveness of at least 75 dB with a weight per area of 70 to 90 g/m² and a thickness in the region of 0.05 to 0.1 mm. The web might be formed with polyester, copper, nickel and a protective layer. A metallized polyester web of this type is e.g. known from the company YSHIELD under the label HNG80, cp. www.yshield.com. As an alternative a metallized polyester web HNG100, a metallized nylon non-woven material HNV80, a fine meshed metallized polyester web HNO60, a web made of stainless steel HEG10 or HEG03, a carbonized polyester non-woven material NCV95, a shielding film MCL61, a shielding film MCF5 of the company YSHIELD might be used, see also www.yshield.com.

The arrangement of a layer, cover or coating on the inner side of the inspection window is in particular of advantage if it is intended to avoid that electromagnetic radiation exits to the outside from the interior of the housing of the freeze dryer. If instead the layer, cover or coating is located on the outside, the electromagnetic radiation propagates from the interior of the freeze dryer through the transparent plastic glass. In this case it might be disadvantageous if the electromagnetic radiation is also transferred to the edge region of the transparent plastic glass and there “bypasses” the layer, cover or coating. In particular in this case it is of advantage if the front side of the transparent plastic glass also comprises a layer, cover or coating. On the other side, it is a disadvantage of the arrangement of the layer, cover or coating on the inner side of the inspection window that infrared radiation passes through the transparent plastic glass up to the inner layer, cover or coating where then the infrared radiation will be reflected. By the passage through the transparent plastic glass and the reflection there is an undesired heating of the transparent plastic glass. This might be avoided if the outer side of the transparent plastic glass is equipped with a layer, cover or coating for reducing the transmissibility for radiation. If the layer, cover or coating is located on the inner side, the layer, cover or coating has to fulfil the high standards for the materials of the inner chamber of the freeze dryer, e.g. standards of the FDA. Furthermore, in some cases in this case the layer, cover or coating will be biased with increased exposure during the operation of the freeze dryer and by the technical vacuum and the temperature applied.

Preferably, in the freeze dryer there is no heating device basing upon electromagnetic waves or microwaves used.

Within the frame of the invention, an at least partially transparent or completely transparent layer, cover or coating is used for being able to inspect the product during the progress of the process.

It is possible that the inventive measures influence the reflecting behavior, the absorbing behavior, the emitting behavior and/or the transmitting behavior which might apply to a radiation from the interior to the outside and to a radiation from the outside to the inside.

The global radiation of the sun (e.g. the midday sun in the summer in the Mediterranean area) primarily has relative radiation intensities above 20% in the wavelength region UVA (315-380 nm), in the range of the visible light (380-780 nm) and in the region infrared A (ER-A; 780-1400 nm). Additionally, it is possible that the used material also reduces the transmissibility for radiation for the wavelength region infrared B (IR-B; 1400-300 nm). According to the invention it is e.g. possible to provide a reduced transmissibility for radiation in one, a plurality or all of the afore mentioned wavelengths regions.

In the leaflet EVONIK Industries: Polymer & Laser Laser-Applikationszentrum, Stand February 2008, on page 17 materials are mentioned which provide a reduced transmission degree. The transmission degree describes the share of the incoming flow of radiation or flow of light which completely passes through a transparent component or the ratio between the radiation flow of the exiting or passing light beam and the radiation flow of the incoming light beam. Here in particular a nano-modified PMMA is used which is labeled as “PLEXIGLAS GS 0Z01” and nanomodified TROGAMID, which is labeled as “TROGAMID RS 6047”. “PLEXIGLAS” and “TROGAMID” are registered trademarks. It is also possible to use these materials within the frame of the invention. A further usable material for reducing the transmissibility for radiation is borosilicate glass which is also distributed under the label “Duran” (registered trademark).

Many variations and modifications may be made to the preferred embodiments of the invention without departing substantially from the spirit and principles of the invention. All such modifications and variations are intended to be included herein within the scope of the present invention, as defined by the following claims.

I claim:

1. A freeze dryer comprising an inspection window made of an organic glass material or an inorganic glass material,
the inspection window comprising a layer, a cover, a coating or an addition having a transmissibility for radiation which is smaller than a transmissibility for radiation of the organic glass material or an inorganic glass material,
a transmissibility for radiation of the inspection window with the addition, layer, cover or coating being smaller than a transmissibility for radiation of the inspection window without the addition, layer, cover or coating.

2. The freeze dryer of claim 1, wherein the inspection window comprises an electrical grounding.

3. The freeze dryer of claim 1, wherein the inspection window is made of a mineral glass material or a crystal glass material.

4. The freeze dryer of claim 1, wherein the inspection window is made of transparent PMMA, PC, PET, SAN or PVC.

5. The freeze dryer of claim 1, wherein the inspection window comprises a thickness in the range of 4 cm to 6 cm.

6. The freeze dryer of claim 1, wherein the inspection window comprises a reduced transmissibility for radiation for light
a) in a frequency region of 380 THz and 790 THz and/or
b) in a frequency range of 900 MHz, 1800 MHz and/or 1900 MHz.

7. The freeze dryer of claim 5, wherein the inspection window comprises a reduced transmissibility for radiation for light
a) in a frequency region of 380 THz and 790 THz and/or
b) in a frequency range of 900 MHz, 1800 MHz and/or 1900 MHz.

8. The freeze dryer of claim 1, wherein
a) a sensor having a stimulation frequency and/or a measurement signal frequency is located in an interior of the freeze dryer and
b) the inspection window has a reduced transmissibility for radiation in the region of the stimulation frequency and/or the measurement signal frequency.

9. The freeze dryer of claim 5, wherein
a) a sensor having a stimulation frequency and/or a measurement signal frequency is located in an interior of the freeze dryer and
b) the inspection window has a reduced transmissibility for radiation in the region of the stimulation frequency and/or the measurement signal frequency.

10. The freeze dryer of claim 1, wherein the inspection window comprises a shielding effectiveness according to the standard IEEE 299-2006 of at least 20 dB.

11. The freeze dryer of claim 5, wherein the inspection window comprises a shielding effectiveness according to the standard IEEE 299-2006 of at least 20 dB.

12. The freeze dryer of claim 1, wherein in an edge region the layer, cover or coating is covered and/or fixed by a cover or a frame.

13. The freeze dryer of claim 5, wherein in an edge region the layer, cover or coating is covered and/or fixed by a cover or a frame.

14. The freeze dryer of claim 1, wherein the inspection window is formed by a door or flap of the freeze dryer.

15. The freeze dryer of claim 10, wherein a control unit of the freeze dryer comprises control logic which causes a temperature in the freeze dryer which is below the freezing temperature of products which are freeze-dried in the freeze dryer with a temperature difference, said temperature difference being adapted to the increased shielding effectiveness of the inspection window.

16. The freeze dryer of claim 1, wherein the layer, cover or coating is applied to a front side of the inspection window.

17. The freeze dryer of claim 1, wherein the inspection window is formed by
a) a lid and/or a housing which together with a base module of the freeze dryer limits a product chamber and/or an ice condenser chamber or
b) a housing of a product chamber of the freeze dryer being formed separately from an outer housing of the freeze dryer and which can be taken out of the outer housing.

18. The freeze dryer of claim 1, wherein a type of layer, cover or coating is used which filters a predetermined wavelength region, wherein the wavelength region comprises a wavelength region upon which at least one component, in particular a marker substance, contained in a product in the freeze dryer reacts.
